(19) United States
(12) Patent Application Publication
(10) Pub. No.: US 2024/0275195 A1
(43) Pub. Date: Aug. 15, 2024

(54) STORAGE BATTERY SYSTEM AND STORAGE BATTERY SYSTEM CHARGING/DISCHARGING CONTROL METHOD

(71) Applicant: Mitsubishi Electric Corporation, Tokyo (JP)

(72) Inventor: Satoshi HARA, Tokyo (JP)

(73) Assignee: Mitsubishi Electric Corporation, Tokyo (JP)

(21) Appl. No.: 18/568,284

(22) PCT Filed: Jun. 17, 2021
(86) PCT No.: PCT/JP2021/022983

§ 371 Date: Dec. 8, 2023

(51) Int. Cl. H02J 7/00

(52) U.S. Cl. CPC H02J 7/005; H02J 7/00716; H02J 7/007182; H02J 7/007194; H02J 2207/20

(57) ABSTRACT

A storage battery system includes: a plurality of connected sets each composed of a storage battery module and a converter; and a charging/discharging control device which controls charging/discharging of the storage battery module. The charging/discharging control device acquires information including a current, a voltage, and a temperature of the storage battery module and a current and a voltage of the converter, and includes: a converter efficiency estimation section which estimates a conversion efficiency of the converter; a storage battery performance estimation section which estimates a storage battery performance including a rated capacity; and an output lower limit value determination section which performs classification into groups in each of which sets have equivalent converter characteristics, and determines output lower limit values on the basis of the rated capacities of the storage battery modules in the groups.

### TECHNICAL FIELD

The present disclosure relates to a storage battery system and a charging/discharging control method for the storage battery system.

### BACKGROUND ART

In association with increase in the number of electric automobiles and hybrid automobiles, methods for reusing degraded batteries and batteries having characteristics that differ depending on the vehicle type, e.g., module-configuration batteries having different voltages and capacities, batteries made from different battery materials, and the like, have been studied. Also, for batteries having become unusable in electric automobiles with large outputs, methods for reusing the batteries for stationary installation with the outputs being small have been studied.

As the reuse methods, a method that includes disassembling a battery into battery cells each of which is a minimum unit and reassembling and using a battery having an equivalent degradation level, and a reuse method that includes disassembling a battery into battery modules and directly using them, have been studied. The method that includes disassembling a battery into battery cells each of which is a minimum unit and reassembling a battery requires high cost, and thus attention has been paid to the method that includes disassembling a battery into battery modules and reusing them for stationary installation. To date, this method has been applied only to batteries having equivalent characteristics, such as batteries having equivalent degradation levels and batteries of the same type.

Meanwhile, control technologies for efficiently using storage battery modules having different characteristics such as capacities and degradation states have been desired in application to a large-sized storage battery system such as a large-capacity storage battery system intended for grids. The large-capacity storage battery system is composed of a plurality of storage battery modules, and the efficiency of the storage battery system is improved by controlling the output of each of the storage battery modules. Also, the efficiency of a converter that is connected to each of the storage battery modules and that converts output power of the storage battery module decreases in a region in which the output of the storage battery module is low, and thus development of a method for control in such a low-output region has been particularly required to be conducted in order to improve efficiency.

In view of this requirement, a control method has been disclosed (see, for example, Patent Document 1). The control method is for a storage battery system in which a plurality of sets each composed of a storage battery and a converter are in parallel to one another and are connected to a power grid. The storage battery system includes a power distribution determination section which distributes the total power of charging/discharging by the plurality of sets each composed of a storage battery and a converter to a plurality of sets each composed of a storage battery and a converter. The power distribution determination section compares a critical power at which the conversion efficiency of each converter becomes equal to or higher than a reference efficiency, and the total power of charging/discharging, with each other. When the total power of charging/discharging is equal to or larger than the critical power, the power distribution determination section determines a to-be-operated set number such that the outputs of all the sets each composed of a storage battery and a converter to be operated become equal to or larger than the critical power.

### CITATION LIST

### Patent Document

Patent Document 1: Japanese Laid-Open Patent Publication No. 2015-162917

### SUMMARY OF THE INVENTION

### Problem to be Solved by the Invention

Patent Document 1 further discloses: making, according to a margin for an upper limit and a lower limit of a charging amount, determination as to output distribution to all the sets each composed of a storage battery and a converter determined to be operated; and selecting sets to be operated, from the viewpoint of managing the remaining life of each of the sets. However, although variation among the capacities of the storage batteries is taken into account, neither a case where storage battery modules having different characteristics as in secondhand batteries or the like are combined with one another nor a case where the efficiencies of converters are different from one another, is taken into account.

The present disclosure has been made to solve the above problem, and an object of the present disclosure is to provide a storage battery system and a charging/discharging control method for the storage battery system, with which operation can be efficiently performed even if storage battery modules having different characteristics and converters having different characteristics are provided.

### Means to Solve the Problem

A storage battery system according to the present disclosure is a storage battery system including:
a plurality of connected sets each composed of a storage battery module and a converter; and
a charging/discharging control device which controls charging/discharging of the storage battery module, wherein
the charging/discharging control device acquires information including a current, a voltage, and a temperature of the storage battery module, and a current and a voltage of the converter,
the charging/discharging control device includes
   a converter efficiency estimation section which estimates a conversion efficiency of the converter on the basis of the acquired information,
   a storage battery performance estimation section which estimates a storage battery performance including at least a rated capacity of the storage battery module on the basis of the acquired information, and
   an output lower limit value determination section which classifies the plurality of sets into one or a plurality of groups on the basis of the conversion efficiencies of the converters estimated by the converter efficiency estimation section, and determines an output lower limit value of each of the storage battery modules such that target conversion efficiencies that are set for the respective groups resulting from the classification are exceeded, and
   the output lower limit value determination section determines, for each of the groups resulting from the classification, the output lower limit value of each of the storage battery modules on the basis of the rated capacity of the storage battery module.

### Effect of the Invention

With the storage battery system and a charging/discharging control method for the storage battery system according to the present disclosure, operation can be efficiently performed also in a low-output region in which the conversion efficiency is low, even if storage battery modules having different characteristics and converters having different characteristics are provided.

### BRIEF DESCRIPTION OF THE DRAWINGS

FIG. 1 is a schematic diagram showing a configuration of a storage battery system according to embodiment 1.

FIG. 2 is a function block diagram showing a configuration of a charging/discharging control device according to embodiment 1.

FIG. 3 is a diagram for explaining power conversion in a storage battery unit provided to the storage battery system according to embodiment 1.

FIG. 4 is a configuration diagram showing an example of a converter of the storage battery unit provided to the storage battery system according to embodiment 1.

FIG. 5 is a diagram for explaining a method for determining output lower limit values of storage battery modules, FIG. 5A showing a configuration and a conversion efficiency curve in an example in which n storage battery units having equal characteristics are used, FIG. 5B showing a configuration and a conversion efficiency curve in an example in which n−2 storage battery units having equal characteristics are used.

FIG. 6 is a diagram for explaining a method for determining output lower limit values by an output lower limit value determination section of the charging/discharging control device according to embodiment 1, and shows configurations and conversion efficiency curves in the case of using storage battery modules, some of which have different characteristics.

FIG. 7 shows rated capacities, coefficients (rated capacity ratios), and output lower limit values of respective storage battery modules in a first unit group shown in FIG. 6.

FIG. 8 shows rated capacities, coefficients (rated capacity ratios), and output lower limit values of respective storage battery modules in a second unit group shown in FIG. 6.

FIG. 9 is a diagram for explaining a specific example of the storage battery modules in the first unit group shown in FIG. 6.

FIG. 10 is a diagram for explaining a method for calculating output lower limit values of the storage battery modules shown in FIG. 3, and shows the result of the calculation.

FIG. 11 is a diagram for explaining a specific example of the storage battery modules in the second unit group 112 shown in FIG. 6.

FIG. 12 is a diagram for explaining a method for calculating output lower limit values of the storage battery modules shown in FIG. 11, and shows the result of the calculation.

FIG. 13 is a flowchart showing a procedure of determining output lower limit values of the respective storage battery modules by the charging/discharging control device according to embodiment 1.

FIG. 14 is a diagram for explaining advantageous effects of control by the charging/discharging control device according to embodiment 1, FIG. 14A showing a case corresponding to a comparative example where the output lower limit value is fixed, FIG. 14B showing a case where output lower limit valves are determined by the charging/discharging control device according to embodiment 1.

FIG. 15 is a diagram for explaining changes due to degradation of storage battery modules in the case corresponding to the comparative example where the output lower limit value is fixed.

FIG. 16 is a diagram for explaining changes due to degradation of the storage battery modules in the case where the output lower limit values are determined by the charging/discharging control device according to embodiment 1.

FIG. 17 is a diagram for explaining a replacement frequency and maintenance cost for the storage battery modules in the case corresponding to the comparative example where the output lower limit value is fixed.

FIG. 18 is a diagram for explaining a replacement frequency and maintenance cost for the storage battery modules in the case where the output lower limit values are determined by the charging/discharging control device according to embodiment 1.

FIG. 19 is a hardware configuration diagram of the charging/discharging control device according to embodiment 1.

### DESCRIPTION OF EMBODIMENTS

Hereinafter, the present embodiment will be described with reference to the drawings. In the drawings, the same or corresponding parts are denoted by the same reference characters.

### Embodiment 1

Hereinafter, a storage battery system according to embodiment 1 will be described with reference to the drawings.

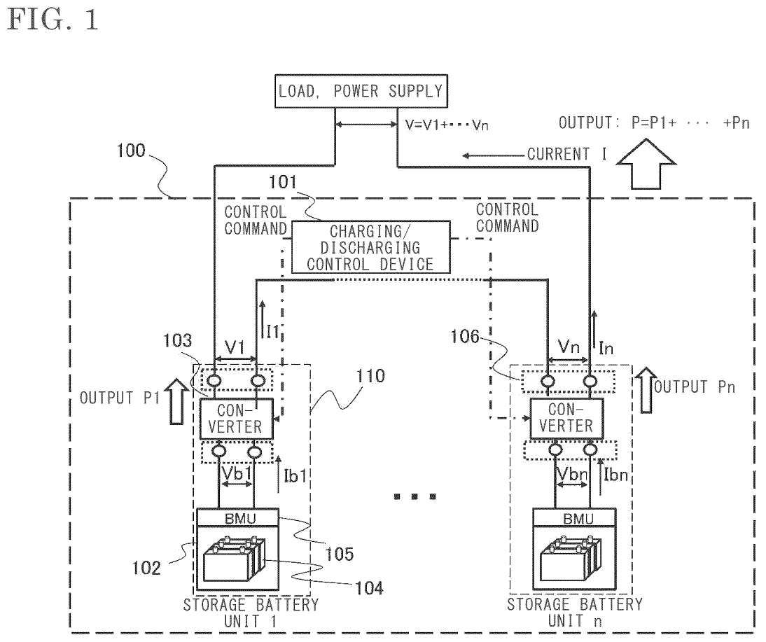

FIG. 1 is a schematic diagram showing a configuration of the storage battery system according to embodiment 1. In FIG. 1, a storage battery system 100 includes a plurality of storage battery units 110 and a charging/discharging control device 101. Each of the storage battery units 110 is provided with a storage battery module 102 and a converter 103, and is connected via connection sections 106 to another storage battery unit 110, and a load or a power supply.

The storage battery module 102 has: a plurality of battery cells 104 each of which is a minimum unit and which are connected in series or parallel; and a battery management unit (hereinafter, referred to as BMU) 105 for monitoring and controlling the battery cells 104.

In the storage battery system 100, if the plurality of storage battery units 110 are connected in series as in FIG. 1, voltages V₁, . . . , and Vₙ of the respective converters 103 are controlled, and meanwhile, if the plurality of storage battery units 110 are connected in parallel, currents I₁, . . . , and Iₙ of the respective converters 103 are controlled, whereby voltages V_{b1}, . . . , and V_{bn} or currents I_{b1}, . . . , and I_{bn} of the respective storage battery modules 102 can be indirectly controlled.

The charging/discharging control device 101 is a device that acquires pieces of information about the respective storage battery modules 102 and that distributes a required output to the load or an input from the power supply, to the storage battery units 110.

As each of the converters 103, an AC/DC converter for converting DC current of the corresponding storage battery module 102 into AC current, a DC/DC converter for converting the voltage of the storage battery module 102 into an arbitrarily-determined voltage, or the like is used, an example thereof being described later.

Each of the battery cells 104 of the storage battery modules 102 is a secondary battery capable of charging/discharging and is, for example, any of a lithium-ion battery, a nickel-hydrogen battery, a lead storage battery, and the like.

For the purpose of preventing overcharging, overdischarging, overvoltage, overcurrent, temperature abnormality, and the like of the battery cell 104, an upper/lower limit voltage, a maximum charging/discharging current, and a maximum cell temperature are set in the BMU 105, and the BMU 105 has a protection function and functions of monitoring the state of the battery cell 104, such as functions of voltage measurement, current measurement, power measurement, temperature measurement, full charge management, and remaining capacity management.

A connection section 106 connects a storage battery module 102 and a converter 103 to each other, and a connection section 106 connects the converter 103 and either of another converter 103 and the load or the power supply to each other. Each of the storage battery units 110 is assumed to have a configuration in which the connection sections 106 make it possible to replace the converter 103 and a portion of the storage battery module 102 excluding the BMU 105, i.e., the group of battery cells 104, or the group of battery cells 104 alone.

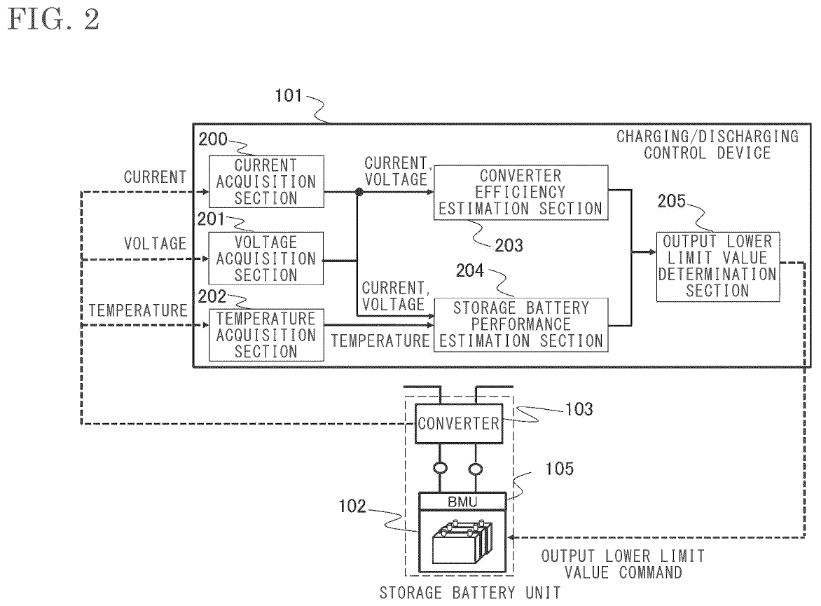

FIG. 2 is a function block diagram showing a configuration of the charging/discharging control device 101 according to embodiment 1. In FIG. 2, the charging/discharging control device 101 includes a current acquisition section 200, a voltage acquisition section 201, a temperature acquisition section 202, a converter efficiency estimation section 203, a storage battery performance estimation section 204, and an output lower limit value determination section 205. The drawing shows one of the plurality of storage battery units 110 as an example and explains the flow of information to and from the charging/discharging control device 101.

The current acquisition section 200, the voltage acquisition section 201, and the temperature acquisition section 202 respectively acquire a current, a voltage, and a temperature of each of the storage battery modules 102 via the corresponding converter 103. The converter efficiency estimation section 203 calculates a conversion efficiency of the converter 103 by using the acquired current value and the acquired voltage value. Although a detailed configuration of the converter 103 will be described later, the converter 103 is desirably configured to be able to measure a current and a voltage of the storage battery module 102.

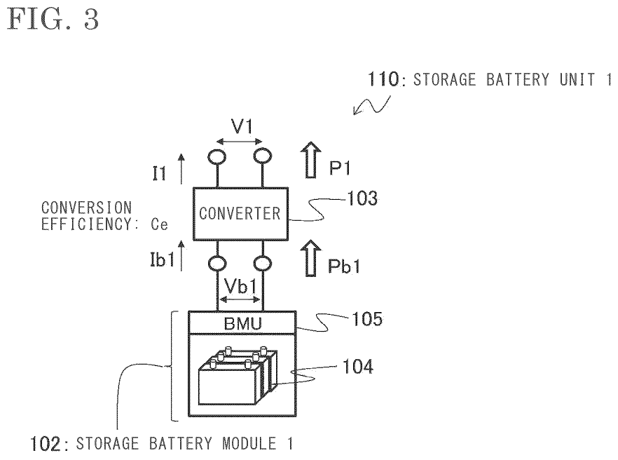

Here, the relationship between an output Pₙ₁ of the storage battery module 102 and a converter output P₁ will be described with reference to FIG. 3. In the storage battery unit 110 provided with the converter 103 and the storage battery module 102 in FIG. 3, the output Pₙ₁ of the storage battery module 102 is expressed as follows by using a conversion efficiency Ce of the converter 103.

$${P}_{b 1} = Ce \cdot {P}_{1} \qquad ( 1 )$$

Here, if the voltage and the current of the storage battery module are respectively defined as V_{b1} and I_{b1}, and a post-conversion voltage and a post-conversion current are respectively defined as V₁ and I₁, expression (1) is transformed as follows.

$${V}_{b 1} \cdot {I}_{b 1} = Ce \cdot {V}_{1} \cdot {I}_{1} \qquad ( 2 )$$

Judging from expression (2), the current I_{b1} of the storage battery module is expressed with the following expression (3).

$$[ Mathematical 1 ]$$

$${I}_{b 1} = Ce \frac{{V}_{1}}{{V}_{b 1}} {I}_{1} \qquad ( 3 )$$

As shown in FIG. 3, a number assigned to each of the storage battery units and a number assigned to the storage battery module thereof correspond to each other as in the storage battery module 1 provided to the storage battery unit 1, and this correspondence applies to the other numbers.

As described above, it is found that the current of the storage battery module 102 can be indirectly controlled by controlling the voltage and the current of the converter 103. Although the converter 103 has the functions of voltage measurement and current measurement in the present embodiment, the measurements may be performed in the storage battery module 102, and the measured voltage and current may be acquired by the BMU 105. In this case as well, the charging/discharging control device 101 only has to be able to acquire these pieces of information from the BMD 105 or via the converter 103 from the BMU 105.

Next, the storage battery performance estimation section 204 of the charging/discharging control device 101 will be described.

The storage battery performance estimation section 204 has a function of estimating a degradation level and a rated capacity as storage battery performances of each of the storage battery modules 102. Estimation of the degradation level of the storage battery module 102 only has to be performed with a general method, and, in the present embodiment, a method of calculating a resistance according to Ohm's law will be described. A resistance value R_{bn} of the storage battery module is correlated with the degradation level of the storage battery module. Thus, the degradation level of the storage battery is ascertained by monitoring the resistance value over time. A voltage V_{bn} and a current Ibn of the storage battery module at a certain time point are acquired, and the resistance value R_{bn} can be calculated as follows.

$${P}_{bn =} {V}_{bn} / {I}_{bn}$$

The time point of calculating the resistance may be any time point. Meanwhile, the resistance value changes according to the charging status and the temperature, and thus, in a state where the charging status and the temperature are equal, an error is small and an accurate degradation state can be detected.

The rated capacity means the amount of electricity capable of being accumulated in the storage battery module and is the sum of currents at the time of charging within a control range (for example, a voltage range from a cell voltage of 2.5 V to a cell voltage of 4.2 V) for the storage battery module.

Cases where the storage battery system 100 is provided with storage battery modules 102 having different characteristics as assumed in the present embodiment include a case where a storage battery module 102 that experiences progressing degradation and that has a decreased rated capacity, and a storage battery module 102 that has a different rated capacity, are connected in the storage battery system 100. Considering this, a rated capacity of each of the storage battery modules 102 is estimated and used for control. As a method for the estimation, a method of obtaining the sum of currents at the time of charging within the specified range (for example, the voltage range from a cell voltage of 2.5 V to a cell voltage of 4.2 V) for the storage battery module 102 as described above may be employed. Alternatively, as a method for the estimation, a method of using a rated capacity transmitted from the BMU 105 of each of the storage battery modules 102 may be employed.

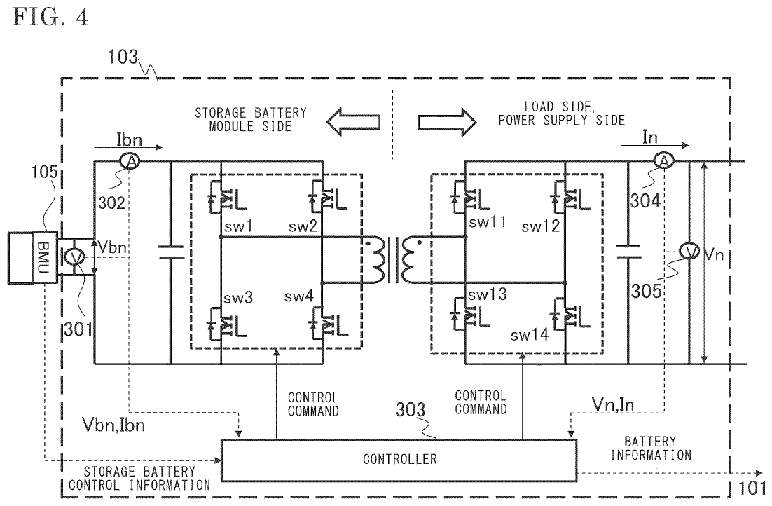

Here, the configuration of the converter 103 will be described with reference to FIG. 4.

FIG. 4 is a configuration diagram showing an example of the converter 103 provided to the storage battery unit 110. The converter 103 has a function of stepping up or stepping down the voltage V_{b} of the storage battery module 102. FIG. 4 shows an example of an insulated converter in which: a full-bridge circuit composed of a switching element SW1 to a switching element SW4 is provided on the storage battery module side; a full-bridge circuit composed of a switching element SW11 to a switching element SW14 is provided on either of the load side and the power supply side; and a transformer is interposed between the full-bridge circuits. The circuit configuration of the converter 103 is not limited to this circuit configuration and may be another circuit configuration or a configuration of either an insulated type or a non-insulated type.

The converter 103 transmits a control command for ON/OFF drive of each of the switching elements in order to step up or step down the voltage V_{b} of the storage battery module 102. In addition, the converter 103 has a voltmeter 301 and an ammeter 302, and a measured voltage V_{bn} and a measured current Ibn of the storage battery module 102 are transmitted to a controller 303. Further, the converter 103 has an ammeter 304 and a voltmeter 305, and a current Iₙ and a voltage Vₙ of the converter 103 measured by the ammeter 304 and the voltmeter 305 are also transmitted to the controller 303. These pieces of information are aggregated in the controller 303, and the resultant information is transmitted to the charging/discharging control device 101 as battery information.

In addition, the storage battery system 100 is characterized as follows. That is, when the storage battery units 110 are connected in series, the sum of the voltages of the respective storage battery units 110 needs to be a voltage V required for either of the power supply and the load. Therefore, the following relationship is established.

$${V}_{1} + {V}_{2} + ⋯ + {V}_{n} = V$$

Meanwhile, when the storage battery units 110 are connected in parallel, the sum of the currents of the respective storage battery units 110 needs to be a current I required for either of the power supply and the load. Therefore, the following relationship is established.

$${I}_{1} + {I}_{2} + ⋯ + {I}_{n} = I$$

Although the converter 103 has the functions of voltage measurement and current measurement, the voltage Vin and the current Ibn of each of the storage battery modules 102 may be measured by the BMU 105 thereof and transmitted to the charging/discharging control device 101. In the case of performing such transmission as well, no problem arises as long as information about the voltage and the current can be acquired in the charging/discharging control device 101.

In this manner, the storage battery performance estimation section 204 of the charging/discharging control device 101 can estimate, from the voltage Vin and the current Ibn of each of the storage battery modules acquired from the BMU 105 thereof or acquired in the corresponding converter 103, a degradation state of the storage battery module according to Ohm's law described above. In addition, the rated capacity can also be calculated from the voltage Von and the current Ibn of the storage battery module acquired in the converter 103, as described above. In a case where the rated capacity of each of the storage battery modules has been ascertained in advance, the rated capacity only has to be obtained from the BMU 105 thereof and does not need to be acquired from the corresponding converter 103.

It is noted that the voltage V_{bn}, the current I_{bn}, and the temperature of the storage battery module may be transmitted from the BMU 105 to the controller 303 of the converter 103 as storage battery control information.

Next, the output lower limit value determination section 205 of the charging/discharging control device 101 will be described. The output lower limit value determination section 205 calculates and determines an output limit value, in a low-load region, of each of the storage battery modules 102 by using: the conversion efficiency of the corresponding converter estimated by the converter efficiency estimation section 203; and the degradation level of the storage battery module 102 and the rated capacity of the storage battery module 102 which are estimated by the storage battery performance estimation section 204. Hereinafter, a method for calculating an output lower limit valve which is the output limit value will be described.

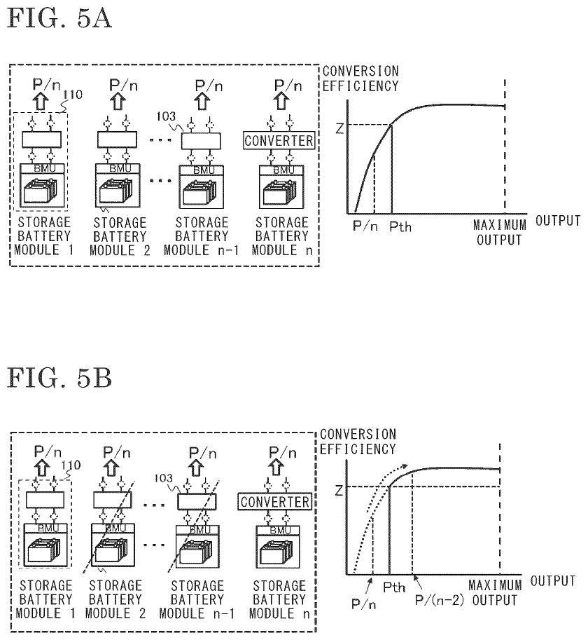

FIG. 5 is a diagram for explaining a method for determining output lower limit values of the storage battery modules, FIG. 5A showing an example in which n storage battery units 110 having equal characteristics are used, FIG. 5B showing an example in which n−2 storage battery units 110 having equal characteristics are used. Here, the phrase “equal characteristics” means that: all the converters 103 of the respective storage battery units 110 have equal converter characteristics, i.e., equal conversion efficiency characteristics; and the storage battery modules 102 of the respective storage battery units 110 also have substantially equal degradation states and substantially equal rated capacities.

In FIG. 5A, the storage battery system 100 has a required output P, and the required output P is equally distributed to n (n is a natural number not smaller than 3) storage battery units. That is, an output P/n [W] is distributed to each of the storage battery units. A conversion efficiency curve of each of the converters is shown, and, in a case where the required output P is low, the efficiency at the distributed output P/n is low according to the conversion efficiency characteristic, whereby the conversion efficiency of the converter might be low. Here, if an output lower limit valve at which the conversion efficiency becomes equal to or higher than a conversion efficiency 2 is defined as Pth, and the output to be borne by each of the storage battery modules is set to be an output not smaller than Pth, the conversion efficiency can be improved.

FIG. 5B shows an example in which the number of the storage battery units 110 having equal characteristics is reduced from n in FIG. 5A by 2, i.e., reduced to n−2. The required output P is equally distributed. That is, an output P/(n−2) [W] is distributed to each of the storage battery units. In this case, on the conversion efficiency curve, the output P/(n−2) is larger than the output lower limit value Pth and, at the output P/(n−2), the conversion efficiency is not lower than Z.

The method of adjusting the number of the storage battery units in this manner does not give rise to any problem in a case where the characteristics of the converters and the characteristics of the storage battery modules are equal. However, in cases such as a case where storage battery modules having different characteristics or converters having different conversion efficiency characteristics are used, the output lower limit values need to be determined in consideration of the different characteristics.

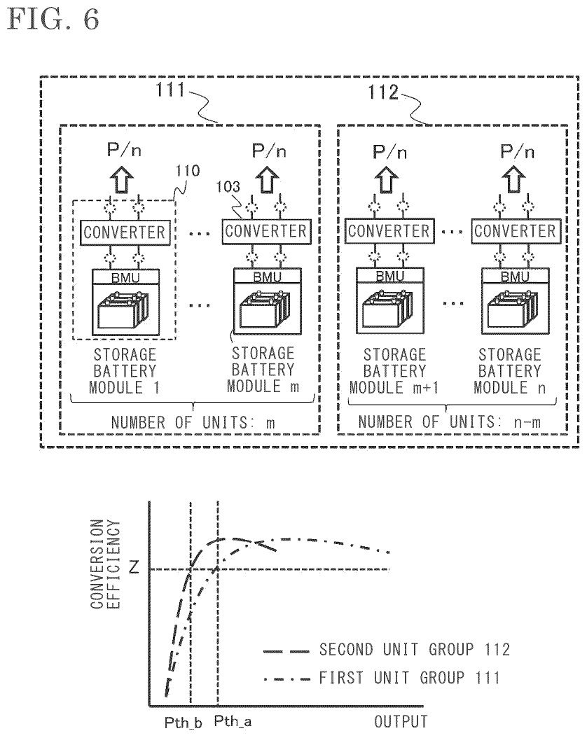

Next, a case where storage battery modules having different characteristics are included will be described. FIG. 6 shows conversion efficiency curves of the converters and a configuration example in which the storage battery system 100 includes therein: a first unit group 111 having m (m is a natural number not smaller than 2 and satisfies m<n) storage battery units 110 having equal characteristics as shown in FIG. 5A; and a second unit group 112 having n−m storage battery units 110 having characteristics that are different from those in the first unit group 111 and that are equal in the unit. The number of the storage battery units 110 in the storage battery system 100 is n, and storage battery modules 102 of the storage battery units 110 in the second unit group 112 are, for example, reuse articles.

In FIG. 6, the conversion efficiency characteristics and the characteristics of the storage battery modules differ between the first unit group 111 and the second unit group 112, and thus different output lower limit values are set for the mutually different conversion efficiency curves. Here, each of the groups has conversion efficiency curves with equal characteristics. That is, in each of the groups, conversion characteristics are equal. An output lower limit value of the storage battery modules in the first unit group 111 at the conversion efficiency Z is Ptha, and an output lower limit value of the storage battery modules in the second unit group 112 at the conversion efficiency Z is Pthb. Hereinafter, a method for determining output lower limit values of the respective storage battery modules in each of the groups will be described.

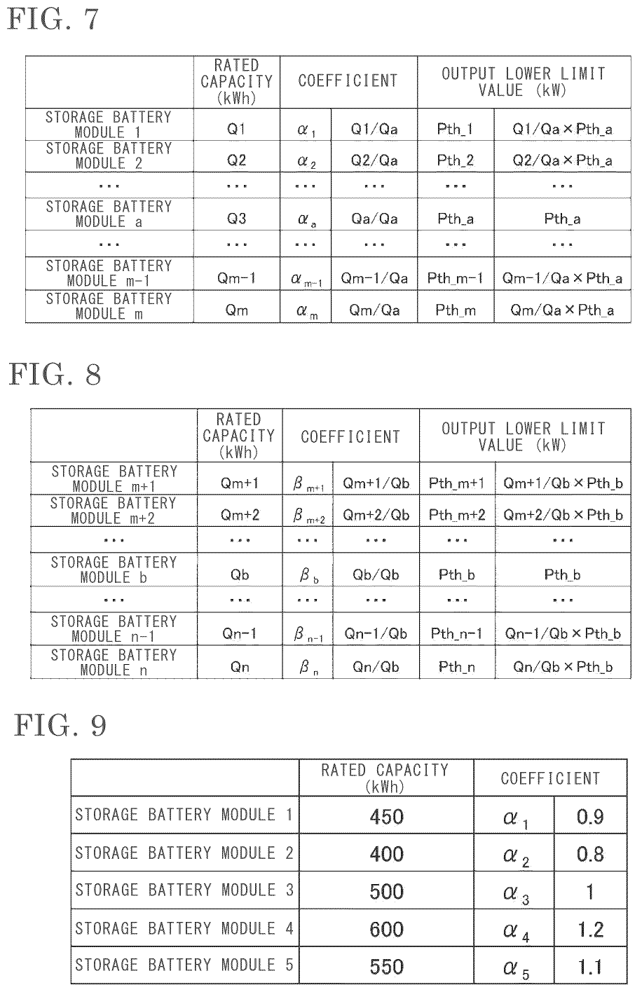

FIG. 7 shows rated capacities, coefficients (rated capacity ratios), and output lower limit values of the respective storage battery modules in the first unit group 111.

First, the rated capacities of a storage battery module 1 to a storage battery module m in the first unit group 111 are respectively defined as Q1, Q2, . . . , Qa, . . . , Qm−1, and Qm. On the basis of the output lower limit value Ptha of the storage battery modules in the first unit group 111 at the conversion efficiency 2 of each of the converters, output lower limit values are distributed according to the rated capacities of the storage battery modules. Output lower limit values Pth_{_1}, . . . , and Pth_{_m} of the respective storage battery modules are expressed with the following expression (4).

$$[ Mathematical 2 ]$$

$${Pth}_{\_ 1} = {α}_{1} \times Pth \_ a \qquad ( 4 )$$

$$⋯$$

$${Pth}_{\_ m} = {α}_{m} \times Pth \_ a$$

Here, each coefficient α is a value corresponding to the rated capacity ratio of the corresponding storage battery module. That is, the coefficients α are expressed as follows.

$$[ Mathematical 3 ]$$

$${α}_{1} = \frac{Q 1}{Qa} \qquad ( 5 )$$

$$⋯$$

$${α}_{m} = \frac{Qm}{Qa}$$

Qa indicates a rated capacity among the rated capacities of the storage battery modules in the first unit group 111, the rated capacity being closest to the average of these rated capacities.

With use of expression (5), the output lower limit values Pth_{_1}, . . . , and Pth_{_n} of the respective storage battery modules are expressed with the following expression (6).

$$[ Mathematical 4 ]$$

$${Pth}_{\_ 1} = {α}_{1} \times {Pth}_{a} = \frac{Q 1}{Qa} \times {Pth}_{a} \qquad ( 6 )$$

$$⋯$$

$${Pth}_{\_ m} = {α}_{m} \times {Pth}_{a} = \frac{Qm}{Qa} \times {Pth}_{a}$$

The sum of the coefficients α is equal to the number of the storage battery modules.

That is, the following relationship is established.

$${α}_{1} + {α}_{2} + ⋯ + {α}_{m - 1} + {α}_{m} = m$$

In this case, if conversion efficiencies corresponding to the output lower limit values of the respective storage battery modules are defined as Z₁, Z₂, . . . , and Zₘ, an average efficiency Z_{α_ave} of the first unit group 111 is calculated with the following expression.

$$[ Mathematical 5 ]$$

$${Z}_{α\_ ave} = \frac{{Z}_{1} + ⋯ + {Z}_{m}}{m} ≃ Z$$

The efficiency of the first unit group 111 has a valve resulting from dividing the sum of the conversion efficiencies at the time of outputting from the respective storage battery modules by the number of the modules, and this value is equal to a target conversion efficiency 2.

For the storage battery modules in the second unit group 112 as well, calculation is performed in the same manner.

FIG. 8 shows rated capacities, coefficients (rated capacity ratios), and output lower limit values of the respective storage battery modules in the second unit group 112.

The rated capacities of a storage battery module m+1 to a storage battery module n in the second unit group 112 are respectively defined as Qm+1, Qm+2, . . . , Qb . . . , Qn−1, and Qn. On the basis of the output lower limit value Pth b of the storage battery modules in the second unit group 112 at the converter efficiency 2, output lower limit values are distributed according to the rated capacities of the storage battery modules. Output lower limit values Pth_{_m+1}, . . . , and Pth_{_n} of the respective storage battery modules are expressed with the following expression (7).

$$[ Mathematical 6 ]$$

$${Pth}_{\_ m + 1} = {β}_{m + 1} \times Pth \_ b \qquad ( 7 )$$

$$⋯$$

$${Pth}_{\_ n} = {β}_{n} \times Pth \_ b$$

Here, each coefficient β is a value corresponding to the rated capacity ratio of the corresponding storage battery module. That is, the coefficients β are expressed as follows.

$$[ Mathematical 7 ]$$

$${β}_{m + 1} = \frac{Qm + 1}{Qb} \qquad ( 8 )$$

$$⋯$$

$${β}_{n} = \frac{Qn}{Qb}$$

Qb indicates a rated capacity among the rated capacities of the storage battery modules in the second unit group 112, the rated capacity being closest to the average of these rated capacities.

With use of expression (8), the output lower limit values Pth_{_m+1}, . . . , and Pth_{_n} of the respective storage battery modules are expressed with the following expression (9).

$$[ Mathematical 8 ]$$

$${Pth}_{\_ m + 1} = {β}_{m + 1} \times Pth \_ b = \frac{Qm + 1}{Qb} \times Pth \_ b \qquad ( 9 )$$

$$⋯$$

$${Pth}_{\_ n} = {β}_{n} \times Pth \_ b = \frac{Qn}{Qb} \times Pth \_ b$$

The sum of the coefficients β is equal to the number of the storage battery modules.

That is, the following relationship is established.

$${β}_{m + 1} + {β}_{m + 2} + ⋯ + {β}_{n - 1} + {β}_{n} = n - m$$

In this case, if efficiencies for the storage battery modules are defined as Zₙ₊₁, Zₙ₊₂, . . . , and Zₙ, an average efficiency Z_{β_ave} of the second unit group 112 is calculated with the following expression.

$$[ Mathematical 9 ]$$

$${Z}_{β\_ ave} = \frac{{Z}_{m + 1} + ⋯ + {Z}_{n}}{n - m} ≃ Z$$

The efficiency of the second unit group 112 has a valve resulting from dividing the sum of the efficiencies at the time of outputting from the respective storage battery modules by the number of the modules, and this value is equal to the target conversion efficiency Z.

Even in the storage battery system including storage battery modules having different characteristics such as those in the first unit group 111 and the second unit group 112 as described above, output lower limit values of the respective storage battery modules in each of the groups can be calculated such that the target conversion efficiency 2 is exceeded in the group. Consequently, in the storage battery system, charging/discharging control can be performed such that the target conversion efficiency Z is exceeded. That is, a storage battery system capable of being efficiently operated can be realized.

Hereinafter, description will be given on the basis of a more specific example.

A storage battery system including ten storage battery units 110 is assumed. Storage battery modules of the respective storage battery units 110 are referred to as storage battery modules 1, 2 . . . , and 10. Description will be given about a case where: the storage battery modules 1 to 5 belong to the first unit group, and the storage battery modules 6 to 10 belong to the second unit group; and it is assumed that converter characteristics in each of the groups are equivalent, and the rated capacities of the storage battery modules in each of the groups are different. Here, there are storage battery modules having different rated capacities, and, if the initial characteristics of the storage batteries are equal, the difference between the rated capacities indicates degradation of the storage batteries.

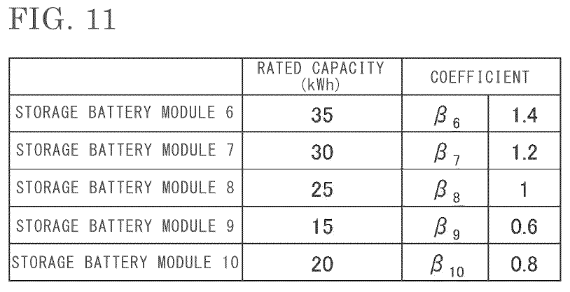

FIG. 9 shows rated capacities of the storage battery modules in the first unit group and coefficients (rated capacity ratios) obtained from the rated capacities, and FIG. 11 shows rated capacities of the storage battery modules in the second unit group and coefficients (rated capacity ratios) obtained from the rated capacities.

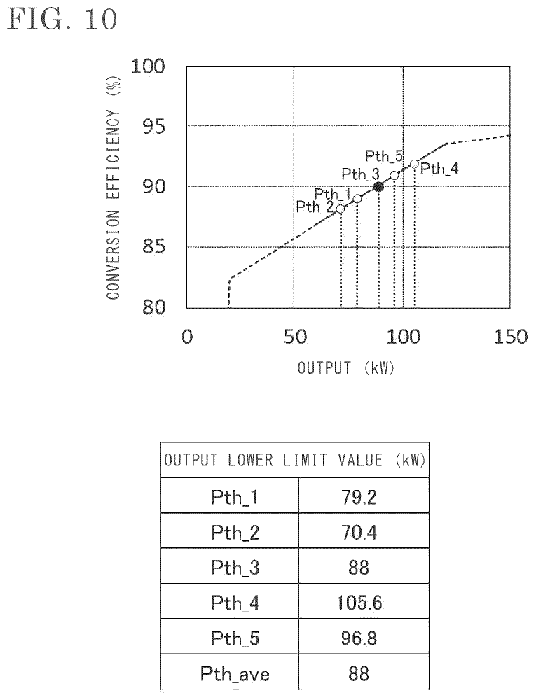

Firstly, the storage battery modules 1 to 5 in the first unit group will be described. FIG. 10 shows a conversion efficiency curve as a converter characteristic of the first unit group, and output lower limit values of the respective storage battery modules obtained by using the conversion efficiency curve. Here, the target conversion efficiency is defined as 90%. The output at which the target conversion efficiency is 90% is 88 [kW]. According to FIG. 9, the storage battery module having a rated capacity closest to the average rated capacity is the storage battery module 3. Thus, output lower limit values of the other respective storage battery modules are calculated on the basis of the rated capacity of the storage battery module 3. Specifically, the output lower limit value Pth 3 of the storage battery module 3 is 88 [kW], and the output lower limit value of each of the other storage battery modules is calculated by multiplying the output lower limit value Pth_{_3} of the storage battery module 3 by the corresponding coefficient. The result of the calculation is shown in FIG. 10.

If this result is plotted on the conversion efficiency curve, it is found that the output lower limit values of the storage battery modules 4 and 5 having high rated capacities are controlled to be large and the output lower limit values of the storage battery modules 1 and 2 having low rated capacities are controlled to be small on the basis of the rated capacity, of the storage battery module 3, that is closest to the average rated capacity. When the outputs are controlled to be equal to or larger than the output lower limit values, the average conversion efficiency of the first unit group can be made higher than 90% which is the target conversion efficiency.

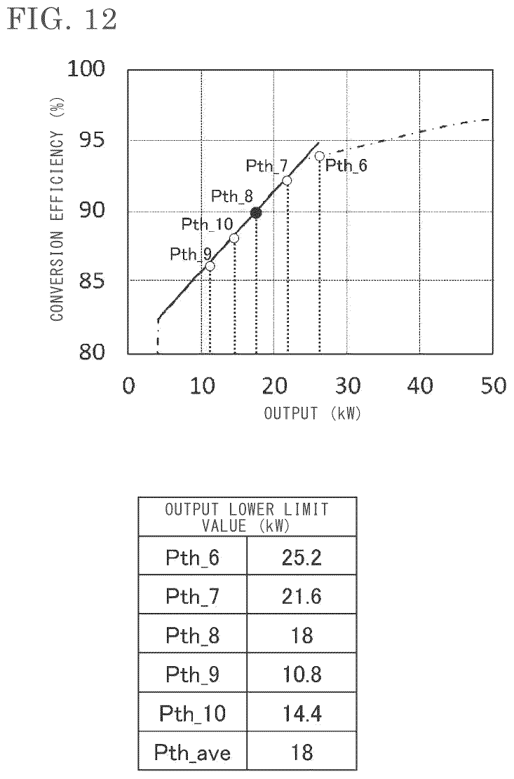

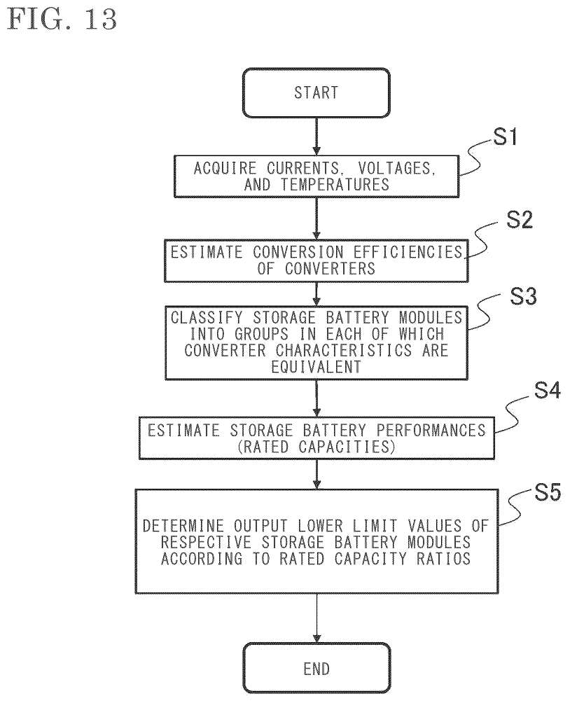

Next, the storage battery modules 6 to 10 in the second unit group will be described. FIG. 12 shows a conversion efficiency curve as a converter characteristic of the second unit group, and output lower limit values of the respective storage battery modules obtained by using the conversion efficiency curve. Here, the target conversion efficiency is defined as 90%. The output at which the target conversion efficiency is 90% is 18 [kW]. According to FIG. 11, the storage battery module having a rated capacity closest to the average rated capacity is the storage battery module 8. Thus, output lower limit values of the other respective storage battery modules are calculated on the basis of the rated capacity of the storage battery module 8. Specifically, the output lower limit value Pth_{_3} of the storage battery module 3 is 18 [kW], and the output lower limit value of each of the other storage battery modules is calculated by multiplying the output lower limit valve Pth_{_8} of the storage battery module 8 by the corresponding coefficient. The result of the calculation is shown in FIG. 12.

If this result is plotted on the conversion efficiency curve, it is found that the output lower limit values of the storage battery modules 6 and 7 having high rated capacities are controlled to be large and the output lower limit values of the storage battery modules 9 and 10 having low rated capacities are controlled to be small on the basis of the rated capacity, of the storage battery module 8, that is closest to the average rated capacity. When the outputs are controlled to be equal to or larger than the output lower limit values, the average conversion efficiency of the second unit group can be made higher than 90% which is the target conversion efficiency.

The averages of the outputs from the storage battery modules classified into the two groups are respectively 88 [kW] and 18 [kW], and the conversion efficiency of the entire storage battery system is 90%.

Although the conversion efficiency curve of the converters is caused to approximate a linear function to determine output lower limit values in the present embodiment and the example, no restriction is imposed on approximation curves, and any approximation expression can be used as long as the conversion efficiency curve of the converters can be explained well with the approximation expression. However, an approximation curve with which the conversion efficiency curve can be accurately explained is desirable. This is because a large error might lead to occurrence of an error between the target conversion efficiency for control and the average of the conversion efficiencies.

Classification into groups in each of which converter characteristics are equal has been performed in advance in the above example. Regarding this, the procedure of a method for determining output lower limit values of the storage battery modules, as well as an approach to classification, will be described in the following flowchart.

FIG. 13 is a flowchart showing the procedure of operation of the charging/discharging control device 101.

When charging/discharging control is started, the charging/discharging control device 101 first acquires voltages V_{bn} and currents I_{bn} of the storage battery modules 102 from the converters 103 or the BMUs 105, and acquires voltages Vₙ and currents Iₙ of the converters 103 from the converters 103 in step S1. In addition, as temperatures, the charging/discharging control device 101 acquires the temperatures of the storage battery modules 102 from the BMUs 105.

In step S2, the converter efficiency estimation section 203 estimates conversion efficiencies and converter characteristics of the converters 103 by using the voltages V_{bn} and the currents I_{bn} of the storage battery modules 102 and the voltages Vₙ and the currents Iₙ of the converters 103 having been acquired. At the time of charging, each of the conversion efficiencies can be calculated from the input of the corresponding storage battery module 102 (voltage V_{bn}×current I_{bn}) and the input of the corresponding converter 103 (voltage Vₙ×current Iₙ). Meanwhile, at the time of discharging, the conversion efficiency can be calculated from the output of the storage battery module 102 (voltage V_{bn}×current I_{bn}) and the output of the converter 103 (voltage Vₙ×current Iₙ). The conversion efficiency characteristics are obtained by plotting the conversion efficiencies with respect to a horizontal axis indicating the inputs or the outputs of the converters.

In step S3, the plurality of storage battery modules 102 are classified, from the estimated conversion efficiency characteristics of the respective converters, into groups of storage battery modules in each of which the converter characteristics are equal or equivalent.

Here, the groups in each of which the converter characteristics are equal or equivalent each refer to a group with a converter characteristic that can be expressed as one conversion efficiency curve resulting from approximation.

In a case where all the converter characteristics are equal or equivalent with respect to the plurality of storage battery modules 102, the number of groups is one.

Next, in step S4, the storage battery performance estimation section 204 estimates performances of the respective storage battery modules 102 by using the voltages V_{bn} and the currents I_{bn} of the storage battery modules 102 and the temperatures of the storage battery modules 102 having been acquired. The estimated performances include rated capacities of the storage battery modules.

In step S5, the output lower limit value determination section 205 obtains, from the estimated rated capacities of the respective storage battery modules, rated capacity ratios (coefficients) in each of the groups resulting from the classification. Meanwhile, the output lower limit value determination section 205 calculates output lower limit values of the respective groups from the conversion efficiency curves of the converters and a target conversion efficiency. The output lower limit value determination section 205 distributes the output lower limit value of each of the groups to the storage battery modules in the group correspondingly to the rated capacity ratios, to determine output lower limit values of the respective storage battery modules.

Each of the output lower limit values having been set through this procedure is inputted to the BMU 105 of the corresponding storage battery module 102, and the BMU 105 performs control such that the output of the storage battery module 102 is equal to or larger than the output lower limit value.

In this manner, even though the storage battery system 100 includes storage battery modules 102 having different performances, the storage battery modules 102 are classified into groups in each of which converter characteristics are equivalent, and output lower limit values of the respective storage battery modules are determined so as to achieve the target conversion efficiencies of the respective groups. Consequently, the storage battery system 100 can perform a highly efficient operation.

Although the output lower limit values are determined according to the rated capacity ratios of the storage battery modules in the present embodiment, the determination does not have to be based on the rated capacity ratios, i.e., the output does not have to be accurately distributed correspondingly to the rated capacity ratios. In this case as well, control is desirably performed such that the output lower limit valves of storage battery modules having high rated capacities are set to be large, and the output lower limit values of storage battery modules having low rated capacities are set to be small.

Hereinafter, advantageous effects of the present embodiment will be described through comparison with a comparative example.

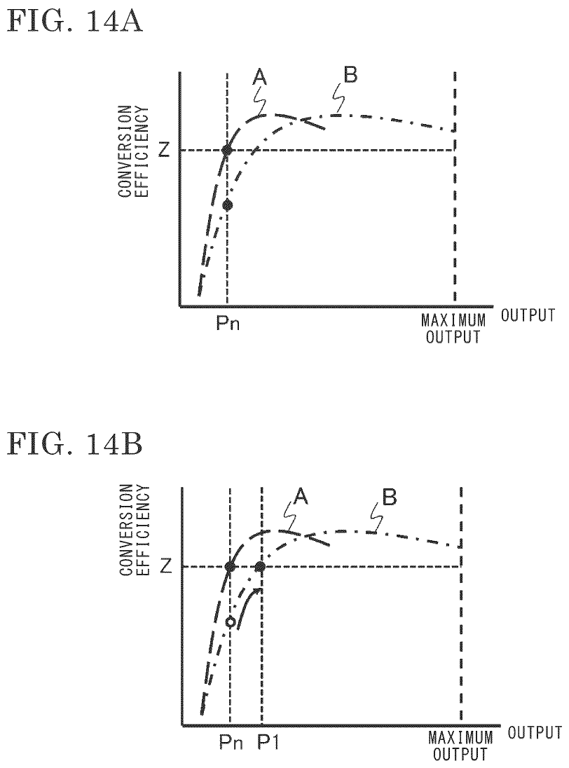

FIG. 14A and FIG. 14B are each a diagram for explaining a method for determining output lower limit values when a plurality of storage battery modules provided to a storage battery system have, for example, two types of converter characteristics.

In a comparative example in FIG. 14A, a plurality of conversion efficiency curves A and B are not assumed. Thus, an output lower limit value is determined on the basis of either of the conversion efficiency curves according to the target conversion efficiency Z, for example. Here, an output lower limit value Pn is determined on the basis of the conversion efficiency curve A. In addition, the output lower limit values of all the storage battery modules are set to the output lower limit value Pn. In this case, the efficiency of a storage battery module having the conversion efficiency curve B is low at the output Pn.

Meanwhile, in the present embodiment in FIG. 14B, output lower limit values Pn and P1 corresponding to the target efficiency Z are determined for the plurality of respective conversion efficiency curves A and B, and thus each type of storage battery module can be efficiently controlled.

By thus determining output lower limit values based on converter characteristics and storage battery module characteristics, the efficiencies of the respective storage battery modules are expected to be increased. As a result, the efficiency, in a low-load region, of the storage battery system is expected to be improved.

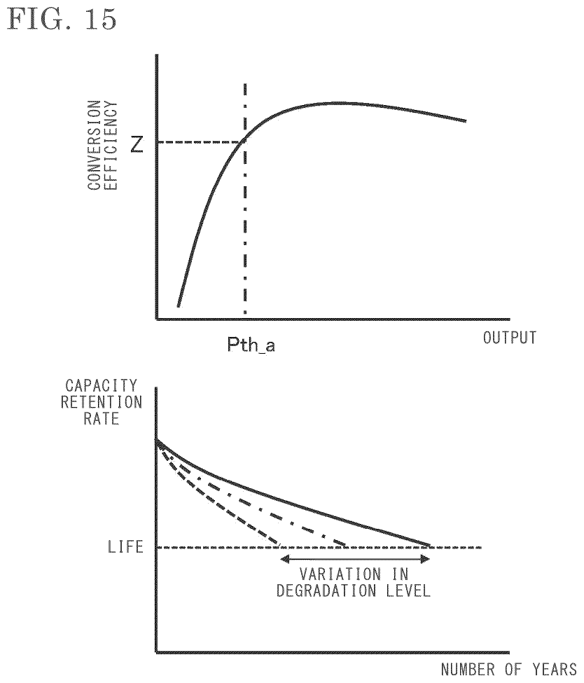

FIG. 15 is related to a storage battery system in the comparative example having a plurality of storage battery modules, FIG. 15 being a diagram for explaining a method for determining an output lower limit value of the storage battery modules and being a diagram showing life curves. Here, an output lower limit value Pth_{_n} determined on the basis of the target conversion efficiency on one conversion efficiency curve with respect to all the storage battery modules as in FIG. 14A is set as an output lower limit value of all the storage battery modules. Thus, the output lower limit value is not set according to the states of the respective storage battery modules. Therefore, it is found that, if the storage battery system is used for a long time, the capacity retention rate of the rated capacity as an index of life decreases, and the rate of the decrease varies among the storage battery modules so that the variation in degradation level increases.

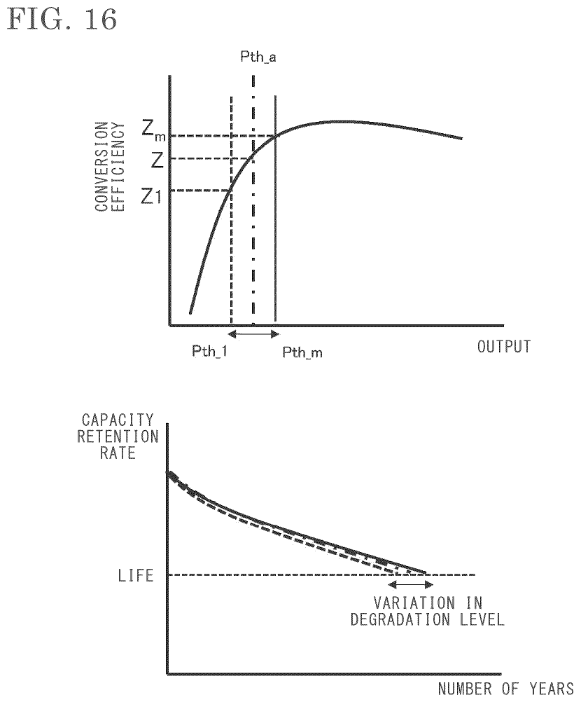

FIG. 16 is related to the storage battery system according to the present embodiment having the plurality of storage battery modules, FIG. 16 being a diagram for explaining a method for determining output lower limit values of the storage battery modules and being a diagram showing life curves. As described above, in the present embodiment, the storage battery modules are classified for each of converter characteristics, and furthermore, the output lower limit value corresponding to the target conversion efficiency Z is distributed according to the rated capacities as indexes of the degradation levels of the storage battery modules such that the average conversion efficiency in each of the groups resulting from the classification becomes the target conversion efficiency Z. Specifically, when m storage battery modules are present in the group as in the upper side of FIG. 16, the output lower limit value is divided into Pth_{_1} to Pth_{_m}. That is, storage battery modules having high rated capacities are set to have output lower limit values larger than the output lower limit value Pth_{_a}, and storage battery modules having low rated capacities are set to have output lower limit values smaller than the output lower limit value Pth_{_a}. It is found that, if the storage battery system is used for a long time with this setting being applied, the capacity retention rate as an index of life decreases, but the difference in the rate of the decrease among the storage battery modules is small so that the variation in degradation level is small.

By thus determining output lower limit values according to degradation levels (rated capacities), the output of a storage battery module having a high degradation level is decreased, and the output of a storage battery module having a low degradation level is increased, whereby the degradation levels can be uniformed. Consequently, the life of the storage battery system itself is expected to be increased, and the variation in degradation level is expected to be decreased.

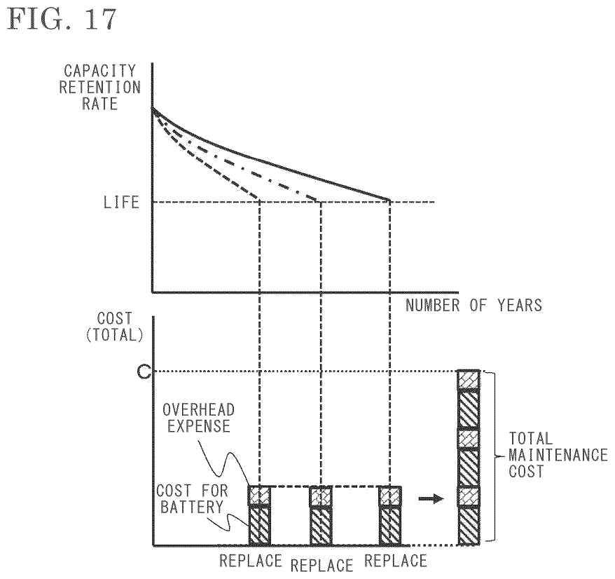

FIG. 17 is related to the storage battery system in the comparative example having the plurality of storage battery modules, FIG. 17 being a diagram for explaining maintenance cost required in the case where there are the life curves shown in FIG. 15. In a case where each time of arrival at the end of a life leads to replacement of the corresponding storage battery module, each time of replacement gives rise to requirement of cost for a battery with which replacement is performed, and overhead expense. The overhead expense refers to cost for a worker who performs the replacement, cost incurred owing to termination of the storage battery system because of the replacement, and the like.

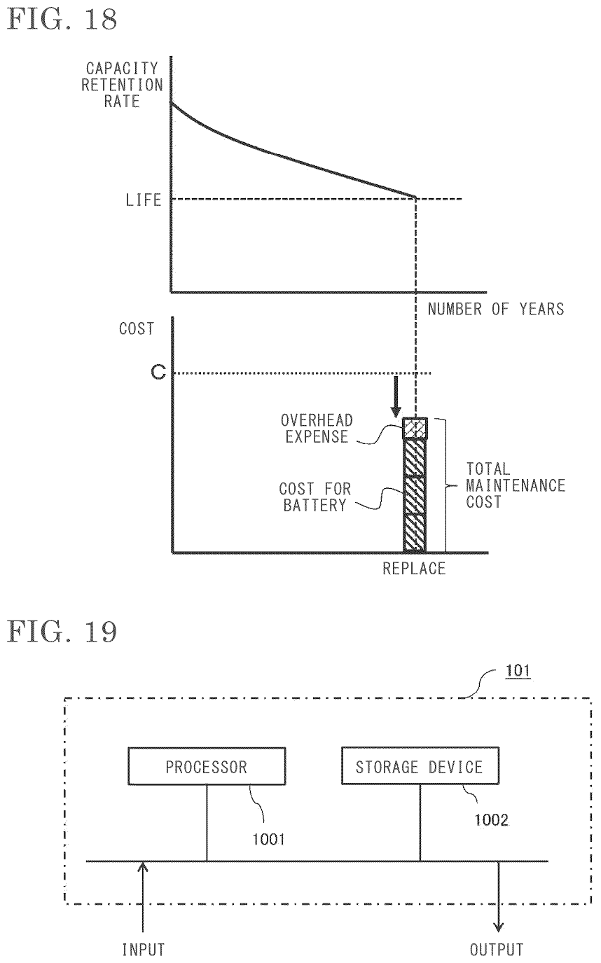

Meanwhile, FIG. 18 is related to the storage battery system according to the present embodiment having the plurality of storage battery modules, FIG. 18 being a diagram for explaining maintenance cost required in the case where there are the life curves shown in FIG. 16. In the present embodiment, the variation among the lives is decreased. Thus, the frequency of replacement decreases, whereby the overhead expense can be decreased. Therefore, the maintenance cost for the storage battery system can be decreased.

The charging/discharging control device 101 in the present embodiment is composed of a processor 1001 and a storage device 1002, an example of hardware of the charging/discharging control device 101 being shown in FIG. 19. Although not shown, the storage device includes a volatile storage device such as a random access memory and a nonvolatile auxiliary storage device such as a flash memory. Alternatively, the storage device may include, as the auxiliary storage device, a hard disk instead of a flash memory. The processor 1001 executes a program inputted from the storage device 1002. In this case, the program is inputted from the auxiliary storage device via the volatile storage device to the processor 1001. Further, the processor 1001 may output data such as a computation result to the volatile storage device of the storage device 1002 or may save the data via the volatile storage device into the auxiliary storage device.

Likewise, the controller 303 provided to each of the converters 103 also has a hardware configuration such as one in FIG. 19, for example, and controls operation of each switching element.

Although an example in which the charging/discharging control device 101 is incorporated in the storage battery system 100 has been described in the present embodiment, the charging/discharging control device 101 does not have to be incorporated in the storage battery system 100.

Although the disclosure is described above in terms of an exemplary embodiment, it should be understood that the various features, aspects, and functionality described in the embodiment are not limited in their applicability to the particular embodiment with which they are described, but instead can be applied alone or in various combinations to the embodiment of the disclosure.

It is therefore understood that numerous modifications which have not been exemplified can be devised without departing from the scope of the specification of the present disclosure. For example, at least one of the constituent components may be modified, added, or eliminated.

### DESCRIPTION OF THE REFERENCE CHARACTERS

100 storage battery system
101 charging/discharging control device
102 storage battery module
103 converter
104 battery cell
105 BMU
106 connection section
110 storage battery unit
111 first unit group
112 second unit group
200 current acquisition section
201 voltage acquisition section
202 temperature acquisition section
203 converter efficiency estimation section
204 storage battery performance estimation section
205 output lower limit valve determination section
301 voltmeter
302 ammeter
303 controller
304 ammeter
305 voltmeter
1001 processor
1002 storage device

1. A storage battery system comprising:
a plurality of connected sets each composed of a storage battery module and a converter; and
a charging/discharging control device which controls charging/discharging of the storage battery module, wherein
the charging/discharging control device acquires information including a current, a voltage, and a temperature of the storage battery module, and a current and a voltage of the converter,
the charging/discharging control device includes
a converter efficiency estimator to estimate a conversion efficiency of the converter on the basis of the acquired information,
a storage battery performance estimator to estimate a storage battery performance including at least a rated capacity of the storage battery module on the basis of the acquired information, and
an output lower limit value determiner to classify the plurality of sets into one or a plurality of groups on the basis of the conversion efficiencies of the converters estimated by the converter efficiency estimator, and determines an output lower limit value of each of the storage battery modules such that target conversion efficiencies that are set for the respective groups resulting from the classification are exceeded, and
the output lower limit value determiner determines, for each of the groups resulting from the classification, the output lower limit value of each of the storage battery modules on the basis of the rated capacity of the storage battery module.

2. The storage battery system according to claim 1, wherein
a plurality of the storage battery modules include a storage battery module having a different storage battery performance.

3. The storage battery system according to claim 1, wherein
a plurality of the converters include a converter having a different converter characteristic.

4. The storage battery system according to claim 1, wherein
the output lower limit value determiner performs setting such that, among the storage battery modules in each of the groups, a storage battery module having a higher rated capacity has a larger output lower limit value.

5. A charging/discharging control method for a storage battery system including a plurality of connected sets each composed of a storage battery module and a converter, the charging/discharging control method comprising:
acquiring information including a current, a voltage, and a temperature of the storage battery module, and a current and a voltage of the converter;
estimating a conversion efficiency of the converter on the basis of the acquired information;
classifying, from the estimated conversion efficiencies of the converters, a plurality of the storage battery modules into groups of storage battery modules, for each of converter characteristics;
estimating a storage battery performance including a rated capacity of each of the storage battery modules on the basis of the acquired information; and
in each of the groups resulting from the classification, distributing, according to the performances of the storage battery modules, an output lower limit value of the group corresponding to a target conversion efficiency which has been set for the group, and determining to determine an output lower limit value of each of the storage battery modules.

6. The storage battery system according to claim 2, wherein
a plurality of the converters include a converter having a different converter characteristic.

7. The storage battery system according to claim 2, wherein
the output lower limit value determiner performs setting such that, among the storage battery modules in each of the groups, a storage battery module having a higher rated capacity has a larger output lower limit value.

8. The storage battery system according to claim 3, wherein
the output lower limit value determiner performs setting such that, among the storage battery modules in each of the groups, a storage battery module having a higher rated capacity has a larger output lower limit value.

9. The storage battery system according to claim 6, wherein
the output lower limit value determiner performs setting such that, among the storage battery modules in each of the groups, a storage battery module having a higher rated capacity has a larger output lower limit value.
